(19) United States
(12) Patent Application Publication
(10) Pub. No.: US 2019/0065999 A1
(43) Pub. Date: Feb. 28, 2019

(54) PRE-PROCESSING OF TRANSIT TRANSACTIONS USING VIRTUAL ACCESS TO MACHINE FUNCTIONALITY

(71) Applicant: Cubic Corporation, San Diego, CA (US)

(72) Inventors: Rasheed Behrooznia, San Diego, CA (US); Fernando Hernandez, San Diego, CA (US); Jorge Septien, Chula Vista, CA (US)

(73) Assignee: Cubic Corporation, San Diego, CA (US)

(21) Appl. No.: 16/116,480

(22) Filed: Aug. 29, 2018

Related U.S. Application Data
(60) Provisional application No. 62/552,234, filed on Aug. 30, 2017.

(51) Int. Cl. G06Q 10/02; G06Q 20/32; G06Q 20/28; G06Q 50/30

(52) U.S. Cl. CPC G06Q 10/02; G06Q 50/30; G06Q 20/28; G06Q 20/322

(57) ABSTRACT

Systems and methods for pre-processing a transaction within a transit system by providing virtual access to transit machine functionality. A method may include generating virtual access data associated with one or more transit machines. The method may also include serving the virtual access data to a portable electronic device, receiving, from the portable electronic device, at least one selection made using at least one input functionality, and in response to receiving the at least one selection, sending a transaction identifier to the portable electronic device, the transaction identifier corresponding to the transaction. The method may further include receiving, at one of the one or more transit machines, user input indicating the transaction identifier and pre-processing the transaction with the at least one selection by modifying data associated with the transaction to include the at least one selection.

### CROSS-REFERENCES TO RELATED APPLICATIONS

This application claims priority to U.S. Provisional Patent Application No. 62/552,234 filed Aug. 30, 2017 titled “REMOTE TICKET VENDING MACHINE ACCESS,” the entire disclosure of which is hereby incorporated by reference, for all purposes, as if fully set forth herein.

### BACKGROUND OF THE INVENTION

As populations in the world's largest city centers continue to grow, often at an exponential rate, public and private transportation systems are becoming increasingly burdened with increased ridership and transit stations are becoming increasingly congested, causing delays to transit users and increased costs to the transportation systems. The use of sophisticated communication devices presents an appealing approach for managing such overcrowding. Unfortunately, existing devices and approaches are insufficient to alleviate these problems. Accordingly, new systems, methods, and other techniques are needed.

### SUMMARY OF THE INVENTION

Examples given below provide a summary of the present invention. As used below, any reference to a series of examples is to be understood as a reference to each of those examples disjunctively (e.g., “Examples 1-4” is to be understood as “Examples 1, 2, 3, or 4”).

Example 1 is a system for pre-processing a transaction within a transit system by providing virtual access to transit machine functionality, the system comprising: a transit server configured to: generate virtual access data associated with one or more transit machines, wherein the virtual access data enables a portable electronic device to virtually access at least one input functionality of the one or more transit machines; serve the virtual access data to the portable electronic device; receive, from the portable electronic device, at least one selection made using the at least one input functionality; and in response to receiving the at least one selection, send a transaction identifier to the portable electronic device, the transaction identifier corresponding to the transaction; and the one or more transit machines configured to: receive user input indicating the transaction identifier; and in response to receiving the user input, pre-processing the transaction with the at least one selection by modifying data associated with the transaction to include the at least one selection, wherein the transaction remains incomplete after the pre-processing.

Example 2 is the system of example(s) 1, further comprising: a display configured to display a barcode at a station system of the transit system, wherein the barcode is configured to provide a link to the virtual access data, and wherein the virtual access data is served to the portable electronic device in response to the portable electronic device reading the barcode.

Example 3 is the system of example(s) 1-2, wherein the transit server is further configured to send the at least one selection and the transaction identifier to the one or more transit machines prior to the one or more transit machines receiving the user input indicating the transaction identifier.

Example 4 is the system of example(s) 1-3, wherein the transit server is further configured to send the at least one selection and the transaction identifier to a particular transit machine of the one or more transit machines in response to the one or more transit machines receiving the user input indicating the transaction identifier, wherein an input device for receiving the user input is positioned at the particular transit machine.

Example 5 is the system of example(s) 1-4, wherein the user input is received via one or both of a keypad and a touchscreen.

Example 6 is the system of example(s) 1-5, wherein the at least one selection includes one or more of: a departure transit station; a departure time; a destination transit station; a number of passengers; and a type of passenger.

Example 7 is the system of example(s) 1-6, wherein the one or more transit machines comprise ticket vending machines.

Example 8 is a method of pre-processing a transaction within a transit system by providing virtual access to transit machine functionality, the method comprising: generating, by a transit server, virtual access data associated with one or more transit machines, wherein the virtual access data enables a portable electronic device to virtually access at least one input functionality of the one or more transit machines; serving the virtual access data to the portable electronic device; receiving, from the portable electronic device, at least one selection made using the at least one input functionality; in response to receiving the at least one selection, sending a transaction identifier to the portable electronic device, the transaction identifier corresponding to the transaction; receiving, at one of the one or more transit machines, user input indicating the transaction identifier; and in response to receiving the user input, pre-processing the transaction with the at least one selection by modifying data associated with the transaction to include the at least one selection, wherein the transaction remains incomplete after the pre-processing.

Example 9 is the method of example(s) 8, further comprising: generating a barcode providing a link to the virtual access data; displaying the barcode on a display at a station system of the transit system; and in response to the portable electronic device reading the barcode, serving the virtual access data to the portable electronic device.

Example 10 is the method of example(s) 8-9, further comprising: prior to receiving the user input indicating the transaction identifier, sending, by the transit server, the at least one selection and the transaction identifier to the one or more transit machines.

Example 11 is the method of example(s) 8-10, further comprising: in response to receiving the user input indicating the transaction identifier, sending, by the transit server, the at least one selection and the transaction identifier to a particular transit machine of the one or more transit machines, wherein an input device for receiving the user input is positioned at the particular transit machine.

Example 12 is the method of example(s) 8-11, wherein the user input is received via one or both of a keypad and a touchscreen.

Example 13 is the method of example(s) 8-12, wherein the at least one selection includes one or more of: a departure transit station; a departure time; a destination transit station; a number of passengers; and a type of passenger.

Example 14 is the method of example(s) 8-13, wherein the one or more transit machines comprise ticket vending machines.

Example 15 is a computer-readable medium for pre-processing a transaction within a transit system by providing virtual access to transit machine functionality, wherein the computer-readable medium comprises instructions that, when executed by one or more processors, cause the one or more processors to perform operations comprising: generating, by a transit server, virtual access data associated with one or more transit machines, wherein the virtual access data enables a portable electronic device to virtually access at least one input functionality of the one or more transit machines; serving the virtual access data to the portable electronic device; receiving, from the portable electronic device, at least one selection made using the at least one input functionality; in response to receiving the at least one selection, sending a transaction identifier to the portable electronic device, the transaction identifier corresponding to the transaction; receiving, at one of the one or more transit machines, user input indicating the transaction identifier; and in response to receiving the user input, pre-processing the transaction with the at least one selection by modifying data associated with the transaction to include the at least one selection, wherein the transaction remains incomplete after the pre-processing.

Example 16 is the computer-readable medium of example(s) 15, wherein the operations further comprise: generating a barcode providing a link to the virtual access data; displaying the barcode on a display at a station system of the transit system; and in response to the portable electronic device reading the barcode, serving the virtual access data to the portable electronic device.

Example 17 is the computer-readable medium of example(s) 15-16, wherein the operations further comprise: prior to receiving the user input indicating the transaction identifier, sending, by the transit server, the at least one selection and the transaction identifier to the one or more transit machines.

Example 18 is the computer-readable medium of example(s) 15-17, wherein the operations further comprise: in response to receiving the user input indicating the transaction identifier, sending, by the transit server, the at least one selection and the transaction identifier to a particular transit machine of the one or more transit machines, wherein an input device for receiving the user input is positioned at the particular transit machine.

Example 19 is the computer-readable medium of example(s) 15-18, wherein the user input is received via one or both of a keypad and a touchscreen.

Example 20 is the computer-readable medium of example(s) 15-19, wherein the at least one selection includes one or more of: a departure transit station; a departure time; a destination transit station; a number of passengers; and a type of passenger.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a transit user downloading virtual access data from a transit server onto a portable electronic device, according to some embodiments of the present invention.

FIG. 2 illustrates a block diagram of a transit system in communication with a portable electronic device, according to some embodiments of the present invention.

FIG. 3 illustrates a block diagram of a station system in communication with a portable electronic device, according to some embodiments of the present invention.

FIG. 4 illustrates a block diagram of a transit system and a method of pre-processing a transaction within a transit system, according to some embodiments of the present invention.

FIG. 5 illustrates a block diagram of a transit system and a method of pre-processing a transaction within a transit system, according to some embodiments of the present invention.

FIG. 6 illustrates various access control points at a transit location, according to some embodiments of the present invention.

FIG. 7 illustrates a method of pre-processing a transaction within a transit system, according to some embodiments of the present invention.

FIG. 8 illustrates a method of pre-processing a transaction within a transit system, according to some embodiments of the present invention.

FIG. 9 illustrates a simplified computer system, according to some embodiments of the present invention.

### DETAILED DESCRIPTION OF THE INVENTION

Embodiments of the present invention include systems, methods, and other techniques for pre-processing a transaction within a transit system by providing virtual access to transit machine functionality. This is accomplished by generating virtual access data at a transit server that, when executed by an electronic device held by a transit user, allows the electronic device to interact with a subset of the transit machine's functionality. The virtual access data may be specifically generated based on the type of transit machine and/or the type of user device so that the virtual access is efficient and reliable. In one example, the virtual access data may be used to display a user interface on a portable electronic device that is similar to the actual interface on a ticket vending machine. In this manner, the passenger may remotely interact with the ticket vending machine while waiting in line to use the machine or while approaching the machine.

In some embodiments, the transaction that is pre-processed is the purchase of a transit product such as a fare card or other transit fare media. For the transaction to be completed, the data associated with the transaction need include at least a minimum number of details regarding the transaction such as the number of passengers, the destination, satisfaction of payment, etc. To reduce passenger wait time and increase passenger throughput, transactions are pre-processed prior to the transit user arriving to the ticket vending machine by, for example, utilizing the transit user's portable electronic device to modify the data associated with the transaction to include at least one detail regarding the transaction.

Once the transit user arrives at the machine, the pre-processed transaction may be retrieved and completed by the transit user resolving (e.g., inputting) the remaining details of the transaction, or by resolving at least one detail until reaching the minimum number of details necessary for the transaction to be considered complete. In many instances, this may include the passenger inserting a cash payment into the ticket vending machine and receiving a fare media. In some embodiments, the transit user may choose any one of several available ticket vending machines at which to complete the pre-processed transaction by inputting a code (e.g., a transaction identifier) at a keypad thereby allowing the ticket vending machine to quickly find the already selected details regarding the transaction. In other embodiments, or in the same embodiments, the transit user may be instructed to approach a particular ticket vending machine.

Several advantages are achieved by way of the present invention. For example, embodiments of the present invention allow passengers who distrust linking financial payment sources to outside entities, such as linking a credit card to a transit system, to use cash payments to complete transactions in an efficient manner. Embodiments of the present invention also improve passenger throughput by bifurcating elements of a transaction into those that may be accomplished with and without direct interaction with a transit machine. In many cases, embodiments allow transit users to use their electronic portable devices to initiate a transaction while accommodating the user's preference for anonymity. Furthermore, where the virtual access data is served to the transit user similar to that employed for a traditional web-browser, the transit user need not install an app on their portable electronic device. In many cases, the virtual access data is served in response to a barcode displayed on the ticket vending machine. The barcode may be station specific and/or periodically renewed, limiting the likelihood that hackers could mount a denial of service attack on the machine or try to break into the transit system.

In some embodiments, transactions may be pre-processed under extreme secure conditions without exposing any vulnerable data to cellular network communications. In such embodiments, the virtual access data may be encrypted using an encryption key prior to being served to the portable electronic device. The encryption key may be included in a barcode that is also generated at the transit server. The barcode may be passed internally through the transit system (e.g., through one or more wide-area or local-area networks) to a display at the transit location, such as a display of the ticket vending machine. Upon reading the displayed barcode, the portable electronic device may obtain the encryption key to decrypt the virtual access data. In some instances, the barcode additionally provides a link (e.g., a web address) allowing the portable electronic device to retrieve the virtual access data over a cellular network. Accordingly, any attack on the cellular network to retrieve the virtual access data will be unsuccessful unless accompanied with the encryption key contained in the displayed barcode. Other advantages of the present invention will be readily apparent to those skilled in the art.

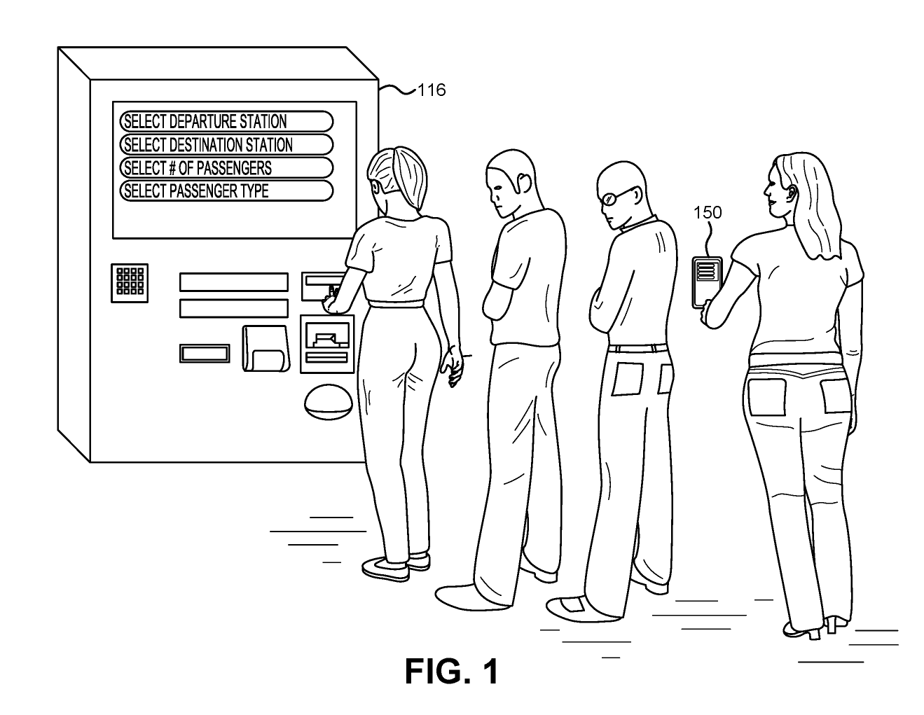

FIG. 1 illustrates one implementation of the present invention in which a transit user, who is waiting in line to use a ticket vending machine 116, downloads virtual access data from a transit server 142 onto his/her portable electronic device 150. The virtual access data enables portable electronic device 150 to virtually access at least one input functionality of ticket vending machine 116, which may include displaying a graphical user interface (GUI) through which the transit user may select a product to purchase. The displayed GUI on portable electronic device 150 may be identical or functionally similar to a GUI displayed on ticket vending machine 116.

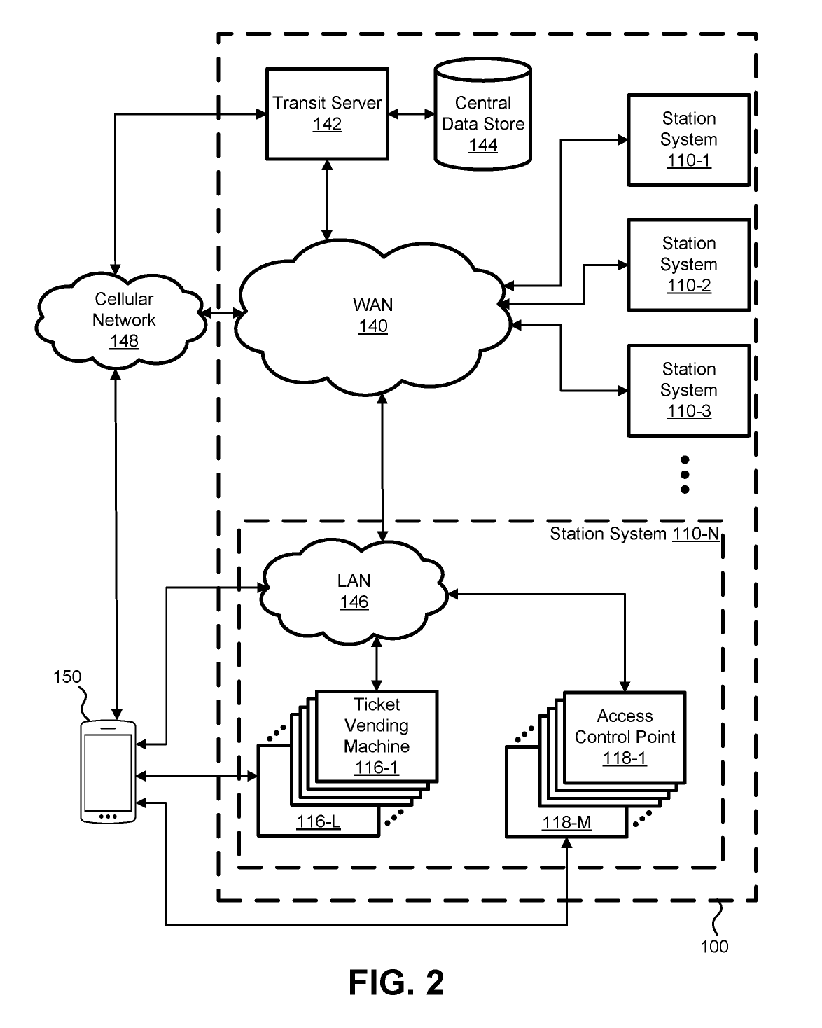

FIG. 2 illustrates a block diagram of a transit system 100 in communication with portable electronic device 150, according to some embodiments of the present invention. Transit system 100 can include various forms of transit, including subway, bus, ferry, commuter rail, para-transit, etc., or any combination thereof. Transit system 100 may include a plurality of station systems 110 located at a plurality of locations (alternatively referred to herein as transit locations). Although station systems 110 are generally considered to be fixed at transit locations where a transit user may begin or end a passage within transit system 100, in some instances a transit vehicle, such as a train or bus, may be considered as one of station systems 110. Transit system 100 achieves interconnectivity between station systems 110 and a transit server 142 via a wide area network (WAN) 140 which may include one or more wired and/or wireless connections. Devices within each of station systems 110 are locally interconnected via a local area network (LAN) 142 which may include one or more wired and/or wireless connections. Data used by transit server 142 in connection with operation of transit system 100 may be stored in a central data store 144 communicatively coupled to transit server 142.

Each of station systems 110 may include a non-restricted access area and a restricted access area. The non-restricted access area may include areas that are freely accessible to the general public, whereas the restricted access area may be reserved exclusively for customers of transit system 100. Examples of a restricted access area may include: the inside of a bus or train, a bus or train platform, the inside of a bus or train station, and the like. Each of station systems 110 may include various transit machines such as ticket vending machines 116 and access control points 118. Typically, each of ticket vending machines 116 is configured to allow a transit user to purchase a transit product such as a train or bus ticket and each of access control points 118 corresponds to a location where a transit product is to be presented or is required to be in the transit user's possession. In some embodiments, each of access control points 118 includes an entry point to transit system 100 that defines a passageway and separates the non-restricted access area from the restricted access area. Examples of access control points 118 include a gate, a turnstile, a platform validator, an entrance/exit to a transit vehicle, among other possibilities. Each of access control points 118 may be communicatively coupled to LAN 146 via one or more wired and/or wireless connections.

In some embodiments, transit users may create and maintain a transit user account. The transit user account can comprise information regarding the transit user, such as a name, address, phone number, email address, user identification (such as a unique identifier of the user or other user ID), passcode (such as a password and/or personal identification number (PIN)), an identification code associated with a fare media used to identify a transit user and/or a transit user account, information regarding user preferences and user opt-in or opt-out selections for various services, product(s) associated with the transit user account, a value and/or credit associated with the product(s), information regarding a funding source for the transit user account, among other possibilities. A transit user may request a transit user account and provide the information listed above by phone (such as a call to a customer service center maintained and/or provided by transit system 100), on the Internet, at one of ticket vending machines 116, or by other means. Transit server 142 can use the information provided by the user to create the transit user account, which can be stored and/or maintained on a database, such as central data store 144.

In some embodiments, a funding source can be linked to a transit user account to provide funding to purchase transit products. The funding source can be external to transit system 100 and can be maintained by a financial institution. Such a funding source may include a savings or checking account, a prepaid account, a credit account, an e-commerce account (such as a PAYPAL® account), or more, which can transfer funds via automated clearing house (ACH) or other means. If a transit user account comprises information regarding a funding source, transit server 142 can use the information to fund purchases or other transactions of a transit user. These transactions can be made at station systems 110, on the Internet, by phone, text, email, or a variety of other different ways, and transaction information can then be sent to transit server 142 to update the transit user account associated with the transactions and reconcile payments and purchases with the funding source. Transit server 142 can communicate with the financial institution (or other entity maintaining the funding source) through a financial network.

A transit user may interact with transit system 100 using a portable electronic device 150 communicatively coupled with various components of transit system 100. Portable electronic device 150 may be a smart phone or other mobile phone (including a near-field-communication (NFC)-enabled mobile phone), a tablet personal computer (PC), a personal digital assistant (PDA), an e-book reader, or other device. A communicative link from portable electronic device 150 to transit server 142 can be provided by a cellular network 148 in communication with WAN 140 or in direct communication with transit server 142. Portable electronic device 150 can thereby access and/or manage information of a transit user account. Furthermore, transit server 142 can send messages to portable electronic device 150 providing transit, account, and/or advertisement information to the user of transit system 100 in possession of portable electronic device 150. Such messages may be based on, among other things, opt-in or opt-out selections and/or other user preferences as stored in a transit user account. A transit user can use portable electronic device 150 to download a transit application from transit server 142 or from a mobile application source. The mobile application source may be an application store or website provided by a mobile carrier or the hardware and/or software provider of portable electronic device 150.

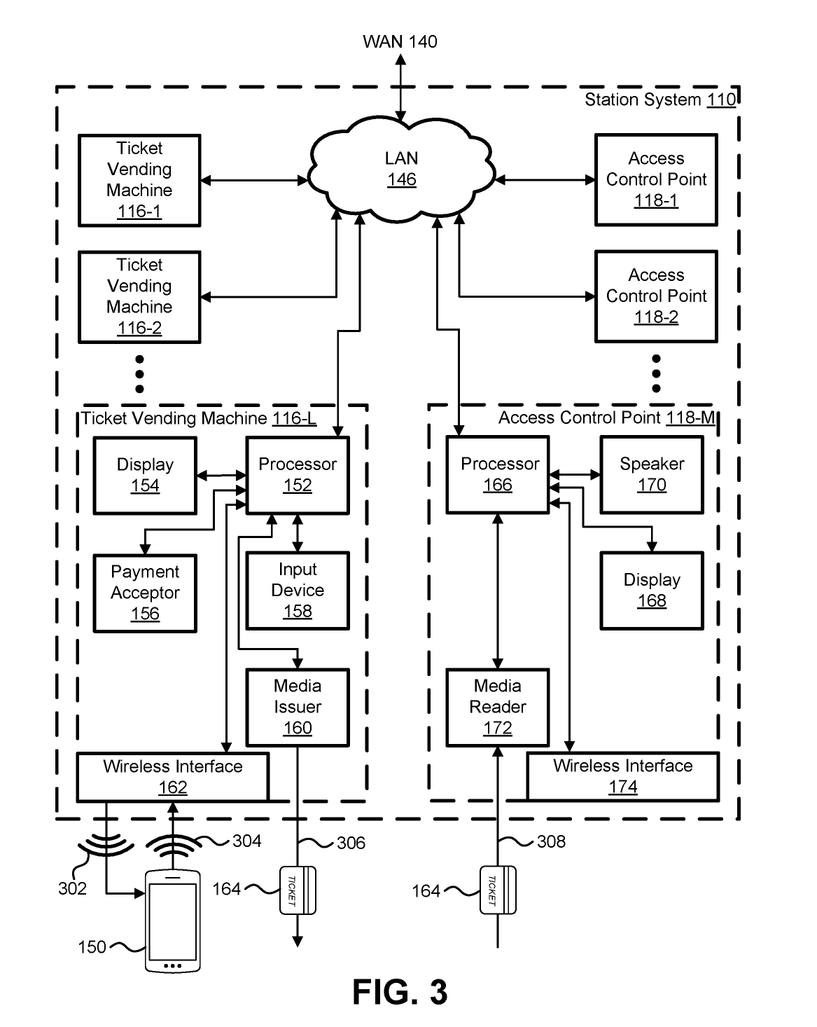

FIG. 3 illustrates a block diagram of station system 110 in communication with portable electronic device 150, according to some embodiments of the present invention. Specific components of ticket vending machines 116 and access control points 118 may vary from that shown in FIG. 3. In some instances, each of ticket vending machines 116 includes a processor 152 communicatively coupled with LAN 146. Processor 152 may include a single or multiple processors and an associated memory. Processor 152 may control a display 154 to display instructions for a transit user and/or a GUI through which the transit user may interact. Each of ticket vending machines 116 may further include a payment acceptor 156 for accepting cash, coin, or card-based payments, an input device 158 (such as a keypad) for receiving input from a transit user, and a media issuer 160 for dispensing a fare media 164 to the transit user. Media issuer 160 may include a printer for printing a new fare media 164 and/or a media reader/writer for adding additional value to an existing fare media 164. Each of ticket vending machines 116 may include a wireless interface 162 for enabling wireless communications between portable electronic device 150 and each of ticket vending machines 116.

In some instances, each of access control points 118 includes a processor 166 communicatively coupled with LAN 146. Processor 166 may include a single or multiple processors and an associated memory. Processor 166 may control a display 168 and a speaker 170 to provide visual and audible instructions for a transit user. Each of access control points 118 may include a media reader 172 for reading fare media 164 and, in conjunction with processor 166, determining whether a transit user is permitted to access the non-restricted access area. Alternatively or additionally, media reader 172 may communicate with portable electronic device 150 to determine whether the transit user is permitted to access the non-restricted access area. Media reader 172 may include a contactless reader and/or a reader that requires contact with the object to be read. In some instances, media reader 172 includes a barcode reader and a barcode display. In some embodiments, display 168 and speaker 170 can give visual and audible instructions to the holder of portable electronic device 150 or fare media 164 that portable electronic device 150 or fare media 164 is not correctly placed to communicate with media reader 172. Each of access control points 118 may include a wireless interface 174 for enabling wireless communications between portable electronic device 150 and each of access control points 118. One of skill in the art will recognize that barriers associated with access control point 118 may open up to allow the holder of portable electronic device 150 or fare media 164 passage upon a successful communication between media reader 172 and portable electronic device 150 or fare media 164.

In some embodiments, wireless interfaces 162 and 174 may enable communication with portable electronic device 150 and fare media 164 by the transmission and reception of electromagnetic wireless signals. For example, devices may communicate using NFC, BLE, radio-frequency identification (RFID), and the like. In some embodiments, media reader 172 may include an RFID reader and fare media 164 may include an RFID tag. The RFID tag may be may be passive, active, or battery-assisted passive. In some embodiments, active RFID tags may be turned on and off by a user pressing a button on the RFID tag. Such embodiments may save power and preserve battery life.

In some embodiments, portable electronic device 150 may receive a wireless signal 302 from wireless interface 162 including virtual access data as described herein. The virtual access data may enable portable electronic device 150 to virtually access at least one input functionality of ticket vending machine 116. After the holder of portable electronic device 150 makes at least one selection using the at least one input functionality, portable electronic device 150 may send wireless signal 304 to wireless interface 162 including the at least one selection. Upon the transit user arriving at ticket vending machine 116 and completing the transaction, fare media 164 may be distributed to the transit user at 306. Upon the transit user arriving at access control point 118, fare media 164 may be read by media reader 172 at 308.

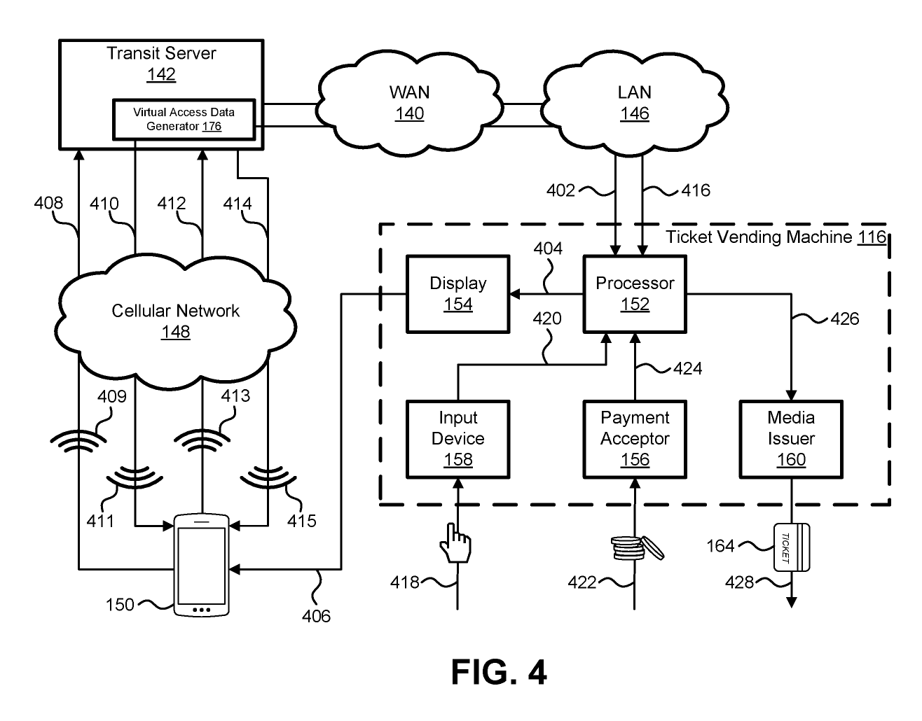

FIG. 4 illustrates a block diagram of transit system 100 and a method of pre-processing a transaction within transit system 100, according to some embodiments of the present invention. In some embodiments, virtual access data and a barcode providing a link to the virtual access data are generated by a virtual access data generator 176 of transit server 142. At 402, the barcode is sent from transit server 142 to processor 152 of ticket vending machine 116 via WAN 140 and LAN 146. At 404, the barcode is sent by processor 152 to display 154 to be displayed. At 406, the barcode is read by portable electronic device 150. At 408, a wireless signal 409 comprising a request for the virtual access data is sent from portable electronic device 150 to transit server 142 via cellular network 148. At 410, a wireless signal 411 comprising the virtual access data is sent from transit server 142 to portable electronic device 150 via cellular network 148. At 412, a wireless signal 413 comprising at least one selection made using the virtual access is sent from portable electronic device 150 to transit server 142 via cellular network 148.

At 414, a wireless signal 415 comprising a transaction identifier is sent from transit server 142 to portable electronic device 150 via cellular network 148. At 416, the at least one selection and the transaction identifier are sent from transit server 142 to processor 152 of ticket vending machine 116 via WAN 140 and LAN 146. At 418, the transit user inputs a transaction identifier into input device 158. At 420, the transaction identifier inputted using input device 158 is sent to processor 152 and is matched with the transaction identifier sent by transit server 142. Thereafter, the transit user is notified of a required payment based on the at least one selection. At 422, the transit user pays the required payment using payment acceptor 156. At 424, payment acceptor 156 notifies processor 152 of a payment amount. Thereafter, processor 152 determines whether the payment amount is equal to (or greater than) the required payment. At 426, processor 152 sends a control signal to media issuer 160 to dispense fare media 164 to the transit user or to add value to an existing fare media 164. At 428, fare media 164 is dispensed to the transit user or value is added to an existing fare media 164.

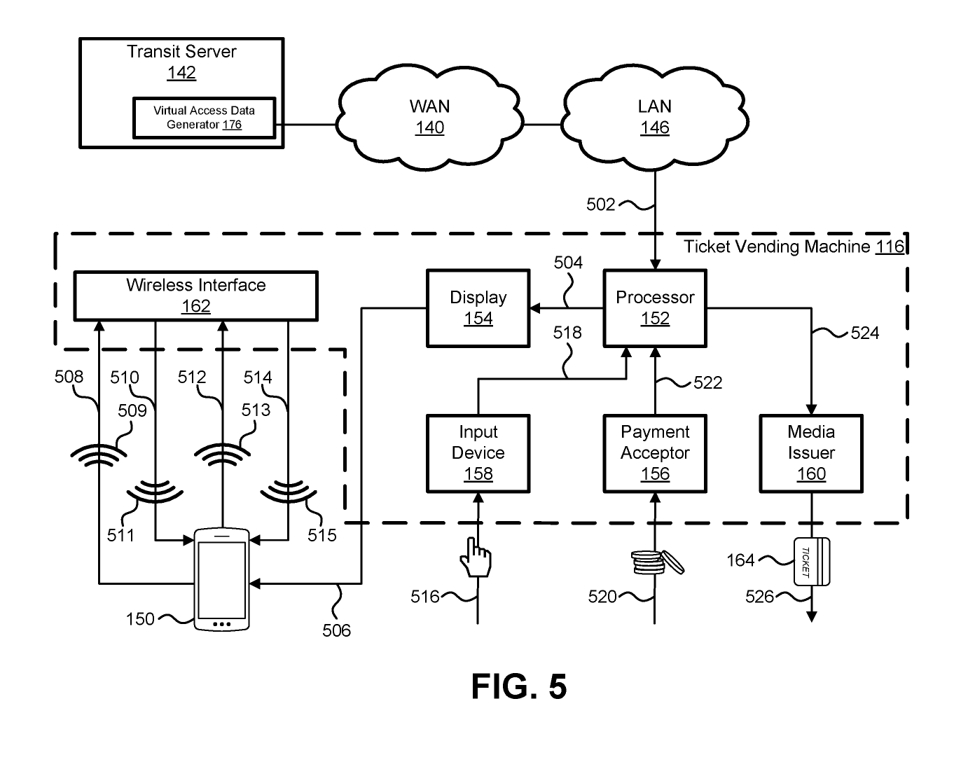

FIG. 5 illustrates a block diagram of transit system 100 and a method of pre-processing a transaction within transit system 100, according to some embodiments of the present invention. In some embodiments, virtual access data and a barcode providing a link to the virtual access data are generated by virtual access data generator 176 of transit server 142. At 502, the barcode is sent from transit server 142 to processor 152 of ticket vending machine 116 via WAN 140 and LAN 146. At 504, the barcode is sent by processor 152 to display 154 to be displayed. At 506, the barcode is read by portable electronic device 150. At 508, a wireless signal 509 comprising a request for the virtual access data is sent from portable electronic device 150 to wireless interface 162. At 510, a wireless signal 511 comprising the virtual access data is sent from wireless interface 162 to portable electronic device 150. At 512, a wireless signal 513 comprising at least one selection made using the virtual access is sent from portable electronic device 150 to wireless interface 162.

At 514, a wireless signal 515 comprising a transaction identifier is sent from wireless interface 162 to portable electronic device 150. At 516, the transit user inputs a transaction identifier into input device 158. At 518, the transaction identifier inputted using input device 158 is sent to processor 152 and is matched with the transaction identifier stored in ticket vending machine 116. Thereafter, the transit user is notified of a required payment based on the at least one selection. At 520, the transit user pays the required payment using payment acceptor 156. At 522, payment acceptor 156 notifies processor 152 of a payment amount. Thereafter, processor 152 determines whether the payment amount is equal to (or greater than) the required payment. At 524, processor 152 sends a control signal to media issuer 160 to dispense fare media 164 to the transit user or to add value to an existing fare media 164. At 526, fare media 164 is dispensed to the transit user or value is added to an existing fare media 164.

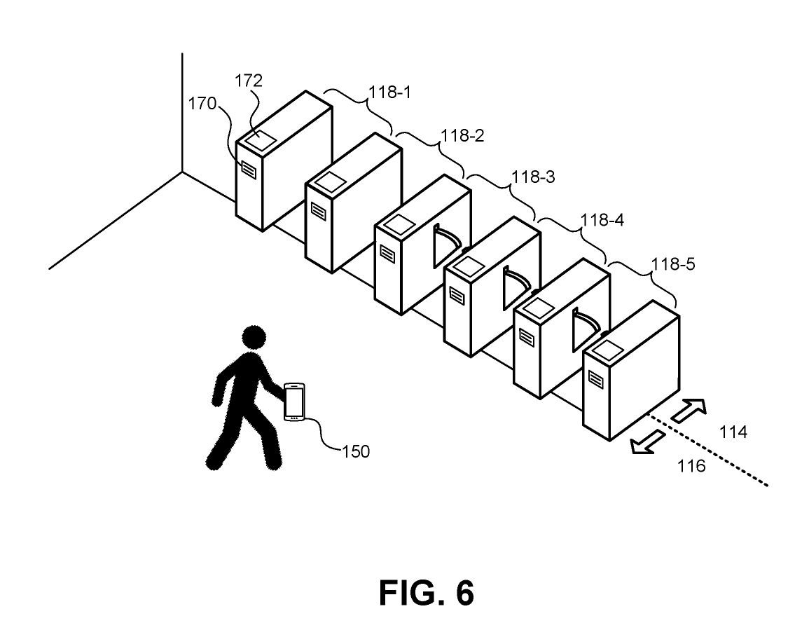

FIG. 6 illustrates various access control points 118 at a transit location, according to some embodiments of the present invention. Access control points 118 may include a plurality of gates separating a restricted access area 114 from a non-restricted access area 116. One or more of access control points 118 may be barrierless (i.e., “gateless”) (e.g., access control points 118-1 and 118-2) and one or more of access control points 118 may include barriers (e.g., access control points 118-3, 118-4, and 118-5). Each of access control points 118 may include media reader 172 positioned along one or both sides of the passageways formed by each of access control points 118. Each of access control points 118 may also include speaker 170 positioned near media reader 172 such that portable electronic device 150 may be near speaker 170 when a barcode displayed by portable electronic device 150 is read by media reader 172.

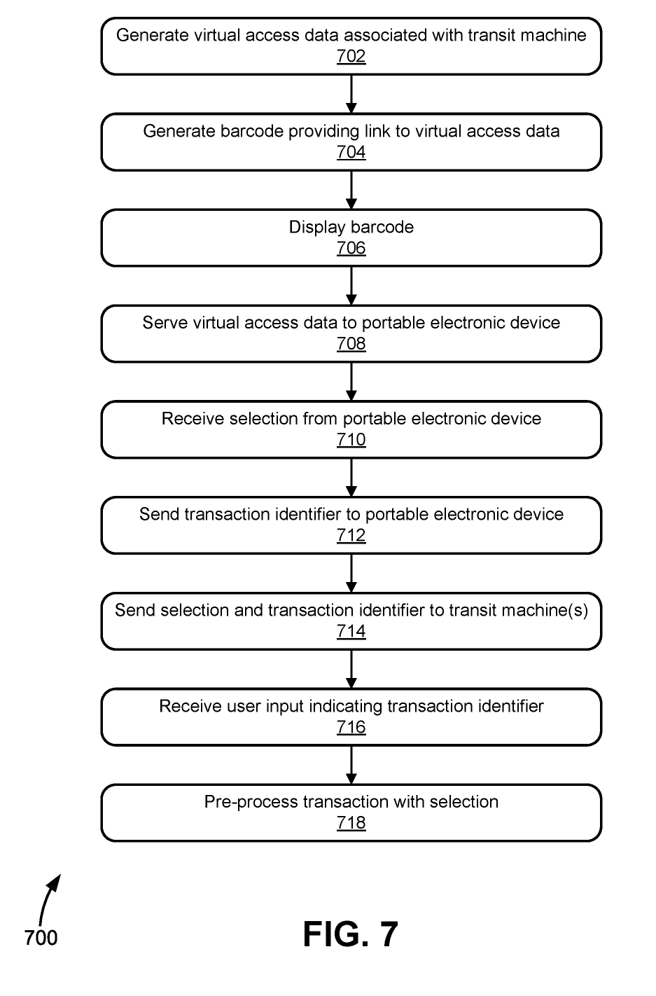

FIG. 7 illustrates a method 700 of pre-processing a transaction within transit system 100, according to some embodiments of the present invention. Steps of method 700 need not be performed in the order shown, and not all steps of method 700 need be performed during performance of method 700. One of more steps of method 700 may be performed by or facilitated by one or more processors of transit server 142, ticket vending machine 116, access control point 118, and/or portable electronic device 150.

At step 702, virtual access data associated with one or more transit machines is generated. The virtual access data may enable portable electronic device 150 to virtually access at least one input functionality of one or more transit machines, such as one or more of ticket vending machines 116 and access control points 118. In some embodiments, the virtual access data is generated by transit server 142 in response to a request made by portable electronic device 150. In some embodiments, transit server 142 may analyze the request to determine a nearest transit machine to portable electronic device 150 and/or a selected transit machine. In some embodiments, transit server 142 may analyze the request to determine a group of possible transit machines. For example, transit server 142 may analyze the request to determine that portable electronic device 150 is at station system 110 and in response may generate virtual access data associated with several ticket vending machines 116 located at station system 110. In some embodiments, the holder of portable electronic device 150 may modify the request to include a transit machine identifier such that transit server 142 may generate virtual access data associated with the particular transit machine identified by the transit machine identifier. Examples of input functionalities of a transit machines may include: an ability to select a departure transit station, an ability to select a departure time, an ability to select a destination transit station, an ability to select a number of passengers, an ability to select a type of passenger, and the like.

At step 704, a barcode providing a link to the virtual access data is generated. In some embodiments, the barcode is generated by transit server 142 prior to, concurrently with, or subsequent to generating the virtual access data. The barcode may be configured such that, in response to portable electronic device 150 reading the barcode, the virtual access data is served to portable electronic device 150. For example, the barcode may include a web address at which the virtual access data can be received (e.g., downloaded). In some embodiments, the virtual access data may be encrypted using an encryption key prior to being served to the portable electronic device. In such embodiments, the encryption key may be included in the barcode so that the encryption key can be passed internally through the transit system, thereby avoiding exposure to cellular network 148 and protecting transit system 100 to any attacks to cellular network 148.

At step 706, the barcode is displayed at station system 110. In some embodiments, the barcode is displayed by a display of a transit machine such as display 154 of ticket vending machine 116. In other embodiments, or in the same embodiments, the barcode is displayed separate from ticket vending machine 116 at a display positioned near an entrance to a line leading to ticket vending machine 116.

At step 708, the virtual access data is served to portable electronic device 150. In some embodiments, the virtual access data is served by transit server 142 to portable electronic device 150. In some embodiments, the virtual access data is served by a transit machine such as ticket vending machine 116 to portable electronic device 150. In some embodiments, prior to serving the virtual access data, transit server 142 may send the virtual access data to the transit machine via WAN 140 and LAN 146 so that the virtual access data may be immediately served by the transit machine upon being requested. In some embodiments, the virtual access data is encrypted using the encryption key prior to being served to portable electronic device 150.

At step 710, at least one selection made using the at least one input functionality is received from portable electronic device 150. The holder of portable electronic device 150 may make and send selections one at a time, or may send the selections once they all have been made. The at least one selection may be received by transit server 142 and/or by a transit machine such as ticket vending machine 116. Examples of the at least one selection may include: a departure transit station, a departure time, a destination transit station, a number of passengers, a type of passenger, and the like.

At step 712, a transaction identifier is sent to portable electronic device 150. The transaction identifier may correspond to the transaction being pre-processed via performance of method 700. The transaction identifier may be sent by transit server 142 and/or by a transit machine such as ticket vending machine 116. The transaction identifier may be sent in response to receiving the at least one selection or, in some embodiments, may be sent concurrently with serving the virtual access data to portable electronic device 150.

At step 714, the at least one selection and the transaction identifier are sent to the one or more transit machines. In some embodiments, the at least one selection and the transaction identifier are sent by transit server 142 in response to receiving the at least one selection.

At step 716, user input indicating the transaction identifier is received at one of the one or more transit machines. For example, a transit user may approach a transit machine such as ticket vending machine 116 and enter the transaction identifier into input device 158 which may include a keypad or a touchscreen. In some embodiments, the transaction identifier may be received by portable electronic device 150 such that it may be subsequently presented and scanned at ticket vending machine 116.

At step 718, the transaction is pre-processed with the at least one selection by modifying data associated with the transaction to include the at least one selection. The transaction may include an electronic record including a plurality of details. One detail of the transaction may be that the transaction is the purchase of a transit product such as a fare media. Another detail of the transaction may be a destination transit station. Another detail of the transaction may be that payment of the transaction has been made. When the transaction is pre-processed, either at least one of the existing details of the transaction is modified or an additional detail is added to the transaction to include the at least one selection. In some embodiments, after being pre-processed the transaction remains incomplete such that the transaction does not include at least a minimum number of details to be completed. In some embodiments, the transaction is considered to be incomplete where it does not include at least a minimum number of details in order to determine a specific transit product.

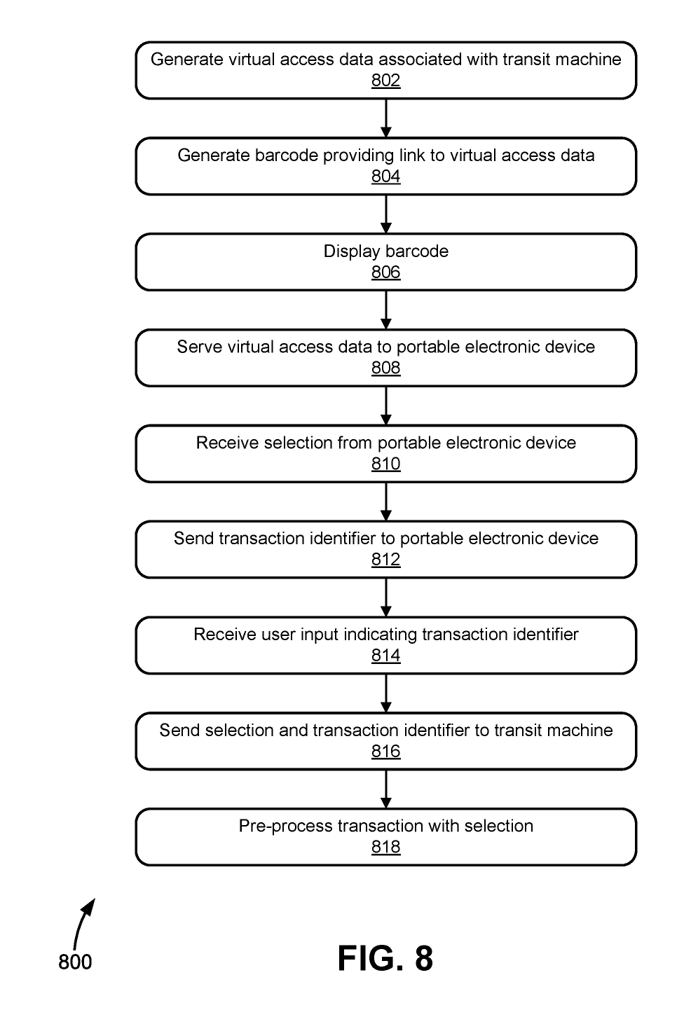

FIG. 8 illustrates a method 800 of pre-processing a transaction within transit system 100, according to some embodiments of the present invention. Steps of method 800 need not be performed in the order shown, and not all steps of method 800 need be performed during performance of method 800. One of more steps of method 800 may be performed by or facilitated by one or more processors of transit server 142, ticket vending machine 116, access control point 118, and/or portable electronic device 150. One or more steps of method 800 may be similar to one or more steps of method 700.

At step 802, virtual access data associated with one or more transit machines is generated. At step 804, a barcode providing a link to the virtual access data is generated. At step 806, the barcode is displayed. At step 808, the virtual access data is served to portable electronic device 150. At step 810, at least one selection made using the at least one input functionality is received from portable electronic device 150. At step 812, a transaction identifier is sent to portable electronic device 150. At step 814, user input indicating the transaction identifier is received at one of the one or more transit machines. At step 816, the at least one selection and the transaction identifier are sent to the one of the one or more transit machines at which the user input was received. At step 818, the transaction is pre-processed with the at least one selection by modifying data associated with the transaction to include the at least one selection.

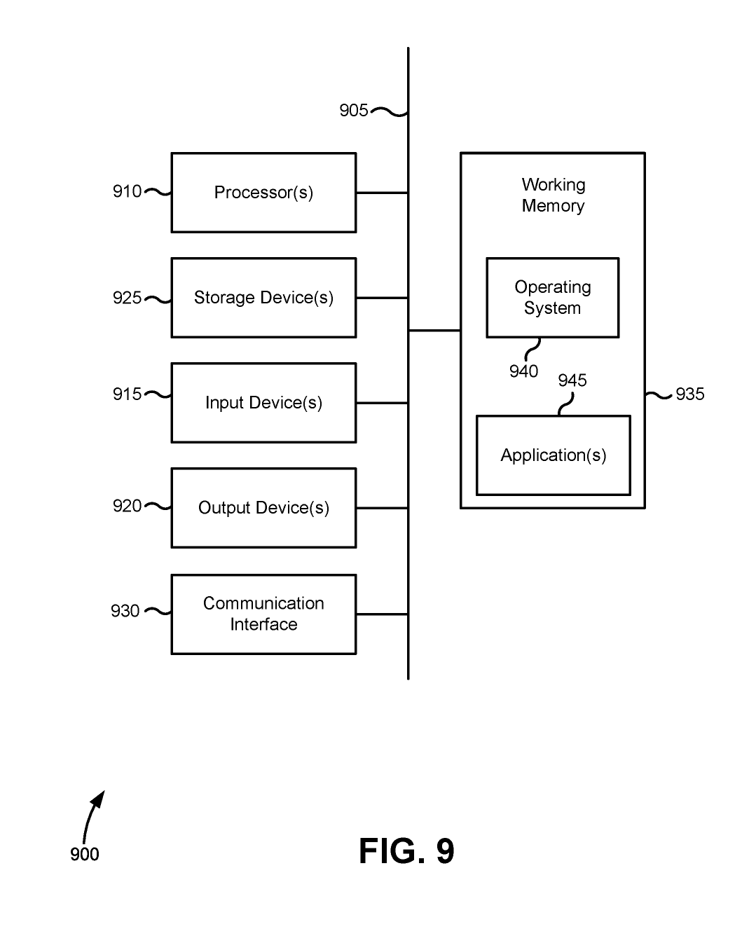

FIG. 9 illustrates a simplified computer system 900, according to some embodiments of the present invention. Computer system 900 may be incorporated as part of the previously described computerized devices. For example, computer system 900 can represent some of the components of transit server 142, ticket vending machine 116, access control point 118, portable electronic device 150, and the like. FIG. 9 provides a schematic illustration of one embodiment of a computer system 900 that can perform the methods provided by various other embodiments, as described herein. FIG. 9 is meant only to provide a generalized illustration of various components, any or all of which may be utilized as appropriate. FIG. 9, therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include a processing unit 910, including without limitation one or more general-purpose processors and/or one or more special-purpose processors (such as digital signal processing chips, graphics acceleration processors, and/or the like); one or more input devices 915, which can include without limitation a keyboard, a touchscreen, receiver, a motion sensor, a camera, a smartcard reader, a contactless media reader, and/or the like; and one or more output devices 920, which can include without limitation a display device, a speaker, a printer, a writing module, and/or the like.

The computer system 900 may further include (and/or be in communication with) one or more non-transitory storage devices 925, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 900 might also include a communication interface 930, which can include without limitation a modem, a network card (wireless or wired), an infrared communication device, a wireless communication device and/or chipset (such as a Bluetooth™ device, an 802.11 device, a Wi-Fi device, a WiMax device, an NFC device, cellular communication facilities, etc.), and/or similar communication interfaces. The communication interface 930 may permit data to be exchanged with a network (such as the network described below, to name one example), other computer systems, and/or any other devices described herein. In many embodiments, the computer system 900 will further comprise a non-transitory working memory 935, which can include a RAM or ROM device, as described above.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a general purpose computer (or other device) to a special purpose computer that is configured to perform one or more operations in accordance with the described methods.

A set of these instructions and/or code might be stored on a computer-readable storage medium, such as the storage device(s) 925 described above. In some cases, the storage medium might be incorporated within a computer system, such as computer system 900. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 910, applications 945, etc.) Further, connection to other computing devices such as network input/output devices may be employed.

Some embodiments may employ a computer system (such as the computer system 900) to perform methods in accordance with the disclosure. For example, some or all of the procedures of the described methods may be performed by the computer system 900 in response to processing unit 910 executing one or more sequences of one or more instructions (which might be incorporated into the operating system 940 and/or other code, such as an application program 945) contained in the working memory 935. Such instructions may be read into the working memory 935 from another computer-readable medium, such as one or more of the storage device(s) 925. Merely by way of example, execution of the sequences of instructions contained in the working memory 935 might cause the processing unit 910 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 900, various computer-readable media might be involved in providing instructions/code to processing unit 910 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 925. Volatile media include, without limitation, dynamic memory, such as the working memory 935. Transmission media include, without limitation, coaxial cables, copper wire and fiber optics, including the wires that comprise the bus 905, as well as the various components of the communication interface 930 (and/or the media by which the communication interface 930 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 930 (and/or components thereof) generally will receive the signals, and the bus 905 then might carry the signals (and/or the data, instructions, etc. carried by the signals) to the working memory 935, from which the processor(s) 905 retrieves and executes the instructions. The instructions received by the working memory 935 may optionally be stored on a non-transitory storage device 925 either before or after execution by the processing unit 910.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

1. A system for pre-processing a transaction within a transit system by providing virtual access to transit machine functionality, the system comprising:
a transit server configured to:
generate virtual access data associated with one or more transit machines, wherein the virtual access data includes data for enabling a portable electronic device to display a same graphical user interface that is displayed by the one or more transit machines and to virtually access at least one input functionality of the one or more transit machines;
serve the virtual access data to the portable electronic device;
receive, from the portable electronic device, at least one selection made using the at least one input functionality; and
in response to receiving the at least one selection, send a transaction identifier to the portable electronic device, the transaction identifier corresponding to the transaction; and
the one or more transit machines configured to:
receive user input indicating the transaction identifier; and
in response to receiving the user input, pre-processing the transaction with the at least one selection by modifying data associated with the transaction to include the at least one selection, wherein the transaction remains incomplete after the pre-processing.

2. The system of claim 1, further comprising:
a display configured to display a barcode at a station system of the transit system, wherein the barcode is configured to provide a link to the virtual access data, and wherein the virtual access data is served to the portable electronic device in response to the portable electronic device reading the barcode.

3. The system of claim 1, wherein the transit server is further configured to send the at least one selection and the transaction identifier to the one or more transit machines prior to the one or more transit machines receiving the user input indicating the transaction identifier.

4. The system of claim 1, wherein the transit server is further configured to send the at least one selection and the transaction identifier to a particular transit machine of the one or more transit machines in response to the one or more transit machines receiving the user input indicating the transaction identifier, wherein an input device for receiving the user input is positioned at the particular transit machine.

5. The system of claim 1, wherein the user input is received via one or both of a keypad and a touchscreen.

6. The system of claim 1, wherein the at least one selection includes one or more of:
a departure transit station;
a departure time;
a destination transit station;
a number of passengers; and
a type of passenger.

7. The system of claim 1, wherein the one or more transit machines comprise ticket vending machines.

8. A method of pre-processing a transaction within a transit system by providing virtual access to transit machine functionality, the method comprising:
generating, by a transit server, virtual access data associated with one or more transit machines, wherein the virtual access data includes data for enabling a portable electronic device to display a same graphical user interface that is displayed by the one or more transit machines and to virtually access at least one input functionality of the one or more transit machines;
serving the virtual access data to the portable electronic device;
receiving, from the portable electronic device, at least one selection made using the at least one input functionality;
in response to receiving the at least one selection, sending a transaction identifier to the portable electronic device, the transaction identifier corresponding to the transaction;
receiving, at one of the one or more transit machines, user input indicating the transaction identifier; and
in response to receiving the user input, pre-processing the transaction with the at least one selection by modifying data associated with the transaction to include the at least one selection, wherein the transaction remains incomplete after the pre-processing.

9. The method of claim 8, further comprising:
generating a barcode providing a link to the virtual access data;
displaying the barcode on a display at a station system of the transit system; and
in response to the portable electronic device reading the barcode, serving the virtual access data to the portable electronic device.

10. The method of claim 8, further comprising:
prior to receiving the user input indicating the transaction identifier, sending, by the transit server, the at least one selection and the transaction identifier to the one or more transit machines.

11. The method of claim 8, further comprising:
in response to receiving the user input indicating the transaction identifier, sending, by the transit server, the at least one selection and the transaction identifier to a particular transit machine of the one or more transit machines, wherein an input device for receiving the user input is positioned at the particular transit machine.

12. The method of claim 8, wherein the user input is received via one or both of a keypad and a touchscreen.

13. The method of claim 8, wherein the at least one selection includes one or more of:
a departure transit station;
a departure time;
a destination transit station;
a number of passengers; and
a type of passenger.

14. The method of claim 8, wherein the one or more transit machines comprise ticket vending machines.

15. A computer-readable medium for pre-processing a transaction within a transit system by providing virtual access to transit machine functionality, wherein the computer-readable medium comprises instructions that, when executed by one or more processors, cause the one or more processors to perform operations comprising:
generating, by a transit server, virtual access data associated with one or more transit machines, wherein the virtual access data includes data for enabling a portable electronic device to display a same graphical user interface that is displayed by the one or more transit machines and to virtually access at least one input functionality of the one or more transit machines;
serving the virtual access data to the portable electronic device;
receiving, from the portable electronic device, at least one selection made using the at least one input functionality;
in response to receiving the at least one selection, sending a transaction identifier to the portable electronic device, the transaction identifier corresponding to the transaction;
receiving, at one of the one or more transit machines, user input indicating the transaction identifier; and
in response to receiving the user input, pre-processing the transaction with the at least one selection by modifying data associated with the transaction to include the at least one selection, wherein the transaction remains incomplete after the pre-processing.

16. The computer-readable medium of claim 15, wherein the operations further comprise:
generating a barcode providing a link to the virtual access data;
displaying the barcode on a display at a station system of the transit system; and
in response to the portable electronic device reading the barcode, serving the virtual access data to the portable electronic device.

17. The computer-readable medium of claim 15, wherein the operations further comprise:
prior to receiving the user input indicating the transaction identifier, sending, by the transit server, the at least one selection and the transaction identifier to the one or more transit machines.

18. The computer-readable medium of claim 15, wherein the operations further comprise:
in response to receiving the user input indicating the transaction identifier, sending, by the transit server, the at least one selection and the transaction identifier to a particular transit machine of the one or more transit machines, wherein an input device for receiving the user input is positioned at the particular transit machine.

19. The computer-readable medium of claim 15, wherein the user input is received via one or both of a keypad and a touchscreen.

20. The computer-readable medium of claim 15, wherein the at least one selection includes one or more of:
a departure transit station;
a departure time;
a destination transit station;
a number of passengers; and
a type of passenger.
